(19) United States
(12) Patent Application Publication
(10) Pub. No.: US 2021/0124871 A1
(43) Pub. Date: Apr. 29, 2021

(54) AUTHORING MANAGEMENT METHOD BASED ON RELATION OF ELECTRONIC DOCUMENTS AND AUTHORING MANAGEMENT SYSTEM

(71) Applicant: Young-Hwa CHO, Seoul (KR)

(72) Inventor: Young-Hwa CHO, Seoul (KR)

(21) Appl. No.: 17/043,544

(22) PCT Filed: Mar. 30, 2019
(86) PCT No.: PCT/KR2019/003756

§ 371 Date: Sep. 29, 2020

(30) Foreign Application Priority Data
Mar. 30, 2018 (KR) 10-2018-0037033
Mar. 30, 2019 (KR) 10-2019-0037510

(51) Int. Cl. G06F 40/166; G06F 16/93; G06F 3/0484

(52) U.S. Cl. CPC G06F 40/166; G06F 3/0484; G06F 16/93

(57) ABSTRACT

An authoring management method includes: a content designated section setting step of setting a designated section of content by input keys of an input device; an authored content collection step of collecting the content of an electronic work, located in the designated section, as authored content; an identification information generation step of generating identification information about the authored content; a correlation collection step of collecting a correlation between the authored content and other authored content; a relation attribute collection step of collecting a relation attribute for the characteristic of a change between the authored content and the other authored content; and an RD generation step of generating an RD by converting the authored content, the identification information, the correlation, and the relation attribute into a dataset.

### BACKGROUND

The present invention relates generally to a relation-based authoring management method for electronic documents and an authoring management system, and more particularly to a relation-based authoring management method for electronic documents and an authoring management system, in which various types of authored content are configured to have correlations in an authored document creation area and three-dimensional relation attributes are set for the correlations, thereby allowing the authored content to be stored and managed as lively information.

In general, a word processor refers to software that is used to create, edit, store, and print documents. Such word processors are convenient not only when creating a new document, but also when retrieving an existing document and checking or modifying its content. Representative word processors are Microsoft Corporation's ‘MS Word®’ and Hangul Co., Ltd.'s ‘Hangul®.’ Such word processors are widely used for simple insertion or removal of images or tables as well as text, support for various fonts, graphics, multiple levels, and various colors. With the recent proliferation of Internet and cloud services, such word processors are developing into web offices. Such word processors have the challenges in which the sharing of electronic documents and collaboration on electronic documents are required, not only the creation or storage of documents but also easy access to created content are enabled anytime and anywhere, the sharing of a document with other persons or the cooperative creation of a document by multiple users (or authors) can be supported, or the mutual relations between documents or the content of documents can be easily understood. In accordance with such changes in the environment, a configuration management technology has been recently proposed.

The configuration management technology is a set of activities for managing the changes of a document, is intended for version management and version control, and is a scheme for applying software development or project management technology to electronic documents. A document management system based on this configuration management technology is proposed in Korean Patent No. 10-1884343 (title of the invention: Document Management System, Method and Terminal). Korean Patent No. 10-188433 proposes a document management system in which documents are managed in such a manner that documents are tracked using the identifiers of document items or in such a manner that a user having authoring authority creates keywords for document items in response to document management requests. The document management system has improved convenience because documents are tracked and managed by identifier or keyword search. However, in the case of this document management system, documents without keywords may be omitted because documents are output by keyword search, there is a limitation to determining organic relations because it is necessary to individually check and determine the mutual content between multiple documents, and a limitation is imposed and there is also a limitation to integrated document management because tracking information is created and managed by a person having separate creation authority.

### SUMMARY OF THE INVENTION

The present invention has been conceived to overcome the above-described problems, and an object of the present invention is to provide a relation-based authoring management method for electronic documents and an authoring management method for implementing the same, in which directional correlations are famed between pieces of authored content during the process of creating or editing electronic documents and three-dimensional relation attributes are defined for the correlations and managed as systematic data, thereby enabling effective monitoring, analysis, and verification through the organic relations between the pieces of authored content.

In order to accomplish the above object, as one preferred example of the present invention, there is provided an authoring management method including: a content designated section setting step of setting a designated section of content by input keys of an input device; an authored content collection step of collecting the content of an electronic work, located in the designated section, as authored content; an identification information generation step of generating identification information about the authored content; a correlation collection step of collecting a correlation between the authored content and other authored content; a relation attribute collection step of collecting a relation attribute for the characteristic of a change between the authored content and the other authored content; and an RD generation step of generating an RD by converting the authored content, the identification information, the correlation, and the relation attribute into a dataset.

Furthermore, as one preferred example of the present invention, there is provided an authoring management system including: an authoring module configured to generate content by the input of an input device; an RD definition module configured to designate a section of the content, to allocate identification information to the section of the content, and to classify the section of the content as authored content; a relation setting module configured to collect a correlation between the authored content and other RD authored content, and to collect a relation attribute for the characteristic of a change between the authored content and the other RD authored content; and a data processing module configured to store an RD, obtained by converting the authored content, the identification information, the correlation, and the relation attribute into a dataset, in an RD storage unit.

In the present invention, pieces of authored content created or being newly created according to changes in the thinking of an author form directional correlations with one or more other pieces of authored content and are mutually connected and attributes are also defined and managed as data, so that changes in the authored content of the author can be easily determined and understood and analysis and verification between pieces of authored content can be performed at all times based on the relation attributes.

Furthermore, changes in authored content can be fundamentally tracked, checked, modified, and supplemented without the need to generate and manage corresponding electronic works as independent data files according to the changes in the authored content, and systematic creation and integrated management can be achieved based on the mutual organic relations between pieces of authored content.

### BRIEF DESCRIPTION OF DRAWINGS

FIG. 1 is a block diagram schematically showing an authoring management system as one preferred example according to the present invention;

FIG. 2 is a flowchart showing a process in which an RD is generated on an electronic document as one preferred example according to the present invention;

FIG. 3 shows an electronic document task window in which an RD setting key is generated as one example according to the present invention;

FIG. 4 shows an electronic document task window in which a correlation collection window and a relation attribute collection window are popped up as one example according to the present invention;

FIG. 5 shows an electronic document task window in which a query window for querying whether or not to recommend a relation attribute and a relation attribute recommendation window are generated as one example according to the present invention;

FIG. 6 is a flowchart showing a process in which an RD is generated as content is created as one example according to the present invention;

FIG. 7 is a block diagram showing the data structure of an electronic document generated by an authoring management system as one embodiment according to the present invention;

FIG. 8 shows an ML document for authored content as a preferred embodiment according to the present invention;

FIG. 9 is a block diagram showing an authoring management system composed of a server-client system as a preferred embodiment according to the present invention;

FIG. 10 shows the summary information of RDs as an example illustrating an authoring management method using RDs according to the present invention;

FIG. 11 is a diagram visually representing the summary information shown in FIG. 10 using nodes and edges;

FIG. 12 is a flowchart showing a process illustrating the relation attribute verification process of an authoring management system as a preferred example according to the present invention; and

FIG. 13 schematically shows a table of authored content for each relation attribute between RDs as a preferred example according to the present invention.

### DETAILED DESCRIPTION OF THE INVENTION

In general, a word processor or document management system is implemented by a combination of hardware and software configurations. Hardware includes a central processing unit (CPU), a memory unit, an input-output unit, a controller, an arithmetic logic unit (ALU), a digital signal processor, a field programmable gate array (FPGA), a programmable logic unit (PLU), etc., and is implemented as one or more general-purpose computers or special-purpose computers. In addition, the processing unit drives an operating system (OS) or one or more applications executed on the OS, and accesses, stores, manipulates, processes, and generates data in response to the execution of software. Such a processing unit may be independently configured, but may include a plurality of processing elements and/or a plurality of types of processing elements. In addition, the software includes an operating system (OS), an input-output control program, and an application program, and allows a processing unit to be operated by a combination of a series of instructions. Software and/or data may be permanently or temporarily embodied via a physical or virtual device, a storage medium, or a transmitted signal wave by a processing unit, or may be distributed over a networked computer system and stored or executed in a distributed manner. Based on such hardware and/or software, a relation-based authoring management method or authoring management system according to the present invention can be implemented. Detailed descriptions of known general technologies will be omitted to ensure ease of description and understanding of components and to avoid unnecessary, redundant descriptions.

The relation-based authoring management method and authoring management system according to the present invention will be described in detail below with reference to the accompanying drawings. For the description of the present invention, terms such as ‘RD,’ ‘authored content,’ ‘identification information,’ ‘correlation,’ ‘relation attribute,’ and ‘dataset’ are used. These terms are terms introduced to describe the features of the present invention, and are distinguished from general terms or terms used in other documents. For the sake of clarity, the terms used in the present invention will be defined as follows:

The ‘RD’ refers to a dataset including authored content, identification information, a correlation, and a relation attribute. The ‘RD’ is a term introduced for convenience of the description and understanding of the present invention. However, generally, a resource description (RD) is used as a term defining the standard of metadata descriptive of various information resources in a web environment. However, this is different from the term ‘RD’ used for the description of the present invention. They must be understood and interpreted separately from each other.

The ‘authored content’ refers to content constituting the content of a work. In this case, this can be a variety of content such as text, an image, a table, a video, and/or a graph. Furthermore, the authored content according to the present invention refers to data itself, not a group of a specific format, such as a file.

The ‘identification information’ refers to information for distinguishing pieces of authored content from each other. In this case, this may be any one or a combination of an ID, which is an identification code, the title and type of an RD, and the size of an RD.

The ‘correlation’ refers to a relationship (a source or a target) present between pieces of authored content, including information about whether or not there is a connection. A piece of authored content may have a correlation with one or more other pieces of authored content.

The ‘relation attribute’ refers to the characteristic of a change between pieces of authored content having a correlation.

The ‘dataset’ refers to a data set regarding authored content, identification information, a correlation, and a relation attribute.

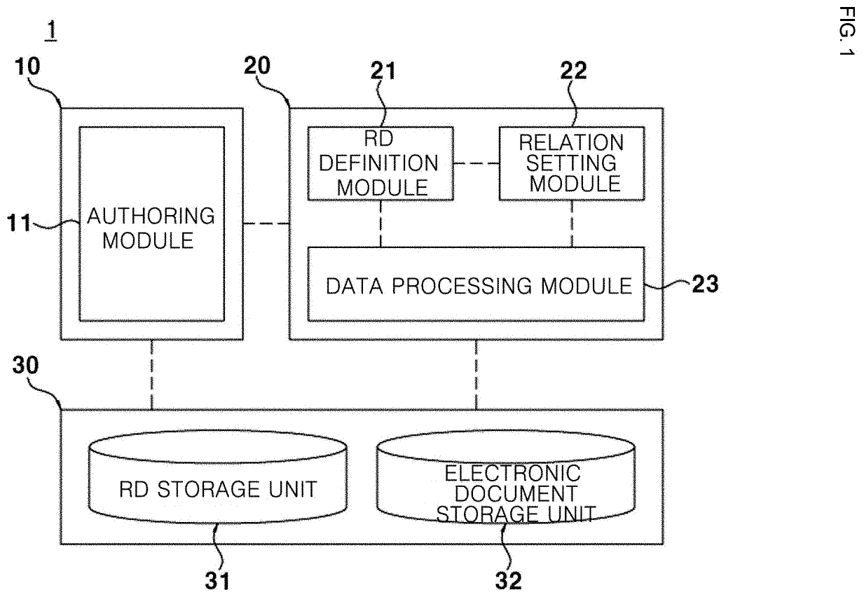

FIG. 1 is a block diagram schematically showing an authoring management system as one preferred example according to the present invention.

Referring to FIG. 1, as one preferred embodiment according to the present invention, an authoring management system 1 includes an electronic document authoring unit 10, an RD generation unit 20, and a storage unit 30 operating on the operating system (OS) of a computer system.

The electronic document authoring unit 10 includes an authoring module 11 for the generation and processing of various types of content (which is used to distinguish it from ‘authored content’ used as an RD element according to the present invention for ease of description), e.g., text, an image, a table, a video, a graph and/or the like, input by an author (or a user) via an input device such as a keyboard, a mouse or the like. In this case, the authoring module 11 is intended to operate as a general word processor. A detailed description of the authoring module 11 will be omitted because well-known word processing technologies may be applied to the creation, storage, etc. of content based on input via a keyboard, a mouse or the like. However, in the authoring management system 1 according to the present invention, the authoring module 11 is different from well-known conventional technologies, and this will be described later in terms of the designation of an RD marker or the generation and display of an RD setting key in the generation or collection of authored content for the construction of an RD.

The RD generation unit 20 operates in conjunction with the electronic document authoring unit 10, and includes an RD definition module 21, a relation setting module 22, and a data processing module 23.

When authored content is designated by an RD marker and an RD setting key to be described later, the RD definition module 21 classifies the authored content as an RD element by separating the authored content from other authored content and collects identification information, and the relation setting module 22 collects the correlation of the authored content and a relation attribute with a target RD. Furthermore, the data processing module 23 generates an RD by using the collected authored content, the identification information, the correlation and the relation attribute as a dataset, and stores the RD in an RD storage unit 31.

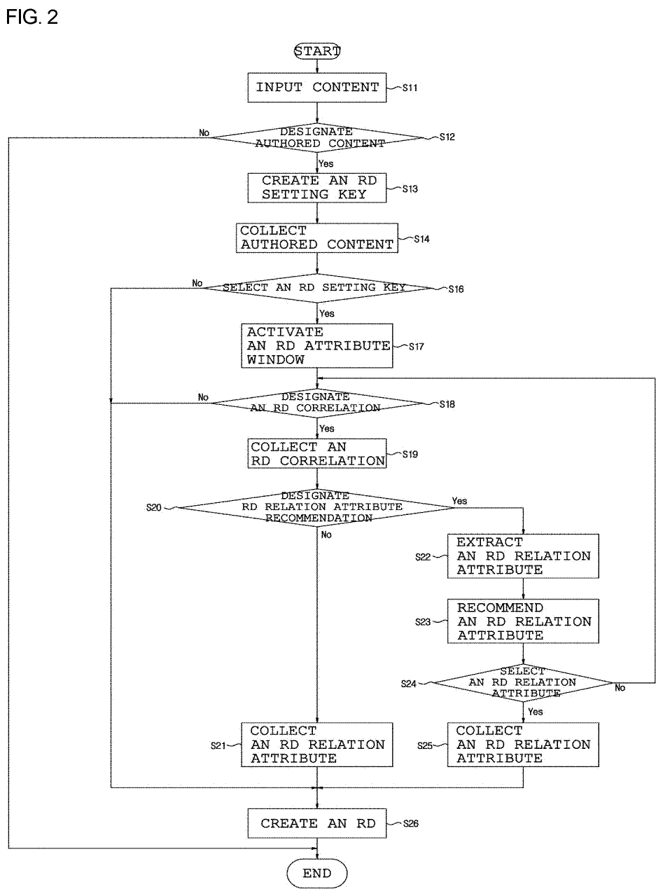

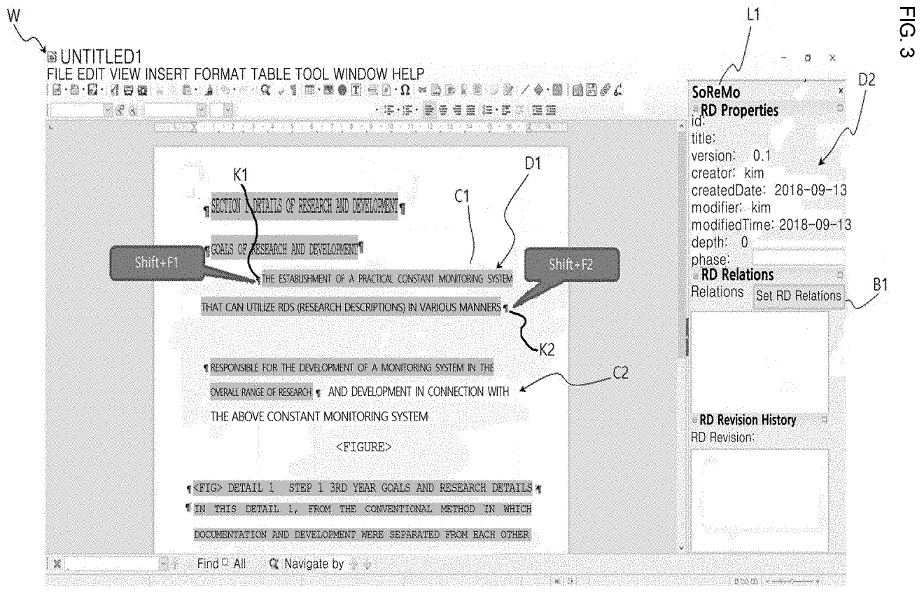

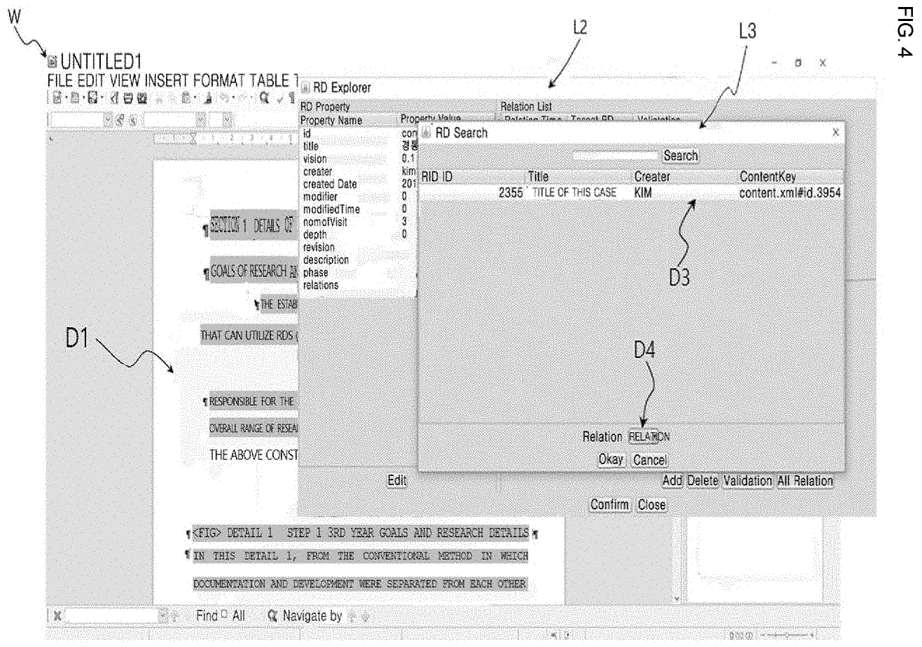

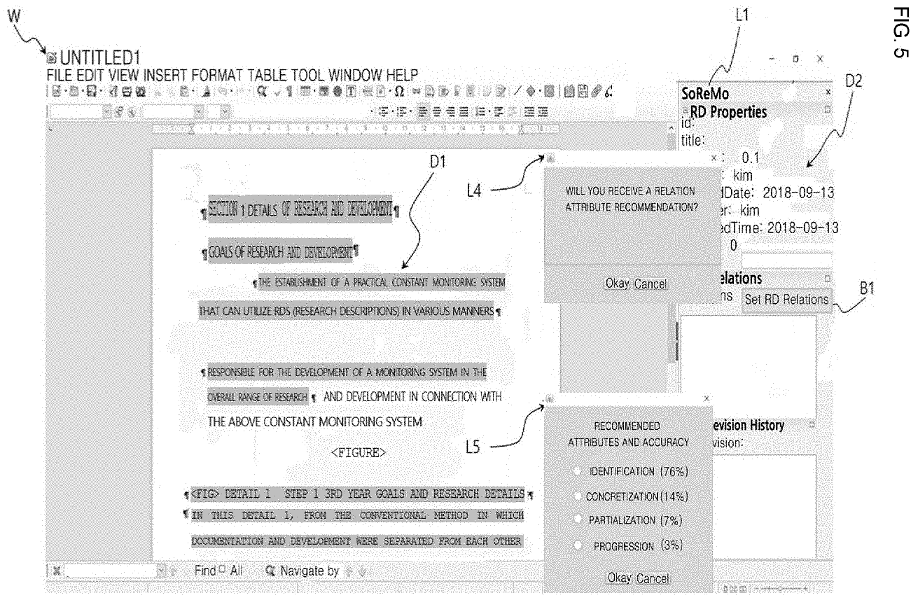

FIG. 2 is a flowchart showing a process in which an RD is generated on an electronic document as one preferred example according to the present invention, FIG. 3 shows an electronic document task window in which an RD setting key is generated as one example according to the present invention, FIG. 4 shows an electronic document task window in which a correlation collection window and a relation attribute collection window are popped up as one example according to the present invention, and FIG. 5 shows an electronic document task window in which a query window for querying whether or not to recommend a relation attribute and a relation attribute recommendation window are generated as one example according to the present invention.

Referring to FIGS. 1 to 5, an author creates content C1 using an input device such as a keyboard or a mouse at step S11. When the author desires to designate the content C1 being created as the authored content D1 of an RD according to the present invention at step S12, an RD marker q is marked at the start point of the content C1 and an RD setting key is generated at the end point of the content C1 at step S13. The RD marker and the RD setting key may be generated in various manners. As an example, the RD marker and the RD setting key may be generated and marked using values corresponding to the input of a keyboard or the input of a mouse. For example, when the input of the keyboard is utilized, the RD marker marks the starting point using shift+F1 and the RD setting key generates a setting key at the end point using shift+F2. When the input of the mouse is utilized, the RD marker is marked by clicking the start point and the RD setting key is generated by clicking the end point.

When the RD marker and the RD setting key are input, the authoring module 11 allocates identification information D2 to the content C1 located between the RD marker K1 and the RD setting key K2 and collects authored content D1 by classifying the content C1 as the authored content D1 at step S14. In this case, the identification information D2 is used to define the authored content D1 as an independent object, and may be constructed in various manners on the basis of convenience in the field of the present invention. As an example, an unique independent object may be obtained by allocating the time values, at which authored content is generated, to the identification information D2 using the RD marker and the RD setting key. Alternatively, the identification information D2 may be obtained by a combination of the ID of a computer or the document name of an electronic document for the convenience of an author or search. The example shown in FIG. 3 is one example in which the authored content D1 is displayed in a state in which the authored content D1 is inverted to be distinguished from the general content C2 by the block designation of the start and end points of the authored content D1.

In this case, the authored content D1 designated by the author displays the identification information D2 of the authored content D1 on an RD attribute window L1 through the activation of the RD attribute window L1 at step S17. In this case, the RD attribute window L1 provides an interface B1 for the input of a correlation and a relation attribute to the author. For this purpose, the relation setting module 22 includes a correlation input unit (not shown) and a relation attribute input unit (not shown). Referring to FIG. 4, the correlation input unit functions as a correlation collection window L2, and allows the author's own RD or another RD of another person to be designated. Furthermore, the relation attribute input unit functions as a relation attribute collection window L3, and allows a relation attribute, associated with the target RD, to be designated.

When an RD (hereinafter the RD designated as having a correlation with the authored content D1 currently being worked on is referred to as the ‘target RD’ to be distinguished from other RDs for ease of description) is input to the correlation collection window L2 at step S18, the relation setting module 22 collects information as a correlation D3 with the target RD having a correlation with the authored content D1 currently being worked on at step S19. Meanwhile, when the target RD is not input, the relation setting module 22 defines the correlation and relation attribute of an undetermined null attribute, and the data processing module 23 generates the correlation and relation attribute of the null attribute, the authored content D1 and the identification information D2 as an RD (hereinafter an RD associated with the authored content currently being worked on is referred to as the ‘original RD’ to be distinguished from other RDs for ease of description) and stores the RD in the RD storage unit 31.

When a relation attribute D4 is input to the correlation collection window L2 and the relation attribute collection window L3, the relation setting module 22 collects relation attribute D4 information about the correlation D3 (a source and a target) between the original RD and the target RD at step S21. Furthermore, the data processing module 23 generates an original RD having the authored content D1, the identification information D2, the correlation D3 and the relation attribute D4 as a single dataset and stores the original RD in the RD storage unit 31 at step S26.

Meanwhile, as shown in FIG. 5, when the correlation D3 is input to the correlation collection window L2 but a relation attribute is not input to the relation attribute collection window L3, the data processing module 23 queries whether or not to recommend a relation attribute via the query window L4 at step S20. When the author selects recommendation in the query window L4, the relation attribute recommendation unit of the relation setting module 22 retrieves the existing target RD information stored in the RD storage unit 30 at step S22, predicts a relation attribute between the authored content of the target RD and the authored content D1 of the original RD by analyzing the authored content of the target RD and the authored content D1 of the original RD in association with each other, and recommends the relation attribute between the original RD and the target RD by outputting the results of the prediction to the relation attribute recommendation window L5 at step S23. The relation attribute recommendation unit supports the determination of a relation attribute appropriate for authored content being worked on, and the author may efficiently and easily determine a relation attribute between the original RD and the target RD by reviewing the relation attributes suggested in the relation attribute recommendation window L5.

When the author reviews the relation attributes suggested by the relation attribute recommendation unit and then enters a relation attribute to the relation attribute entry window L3, the relation setting module 22 collects information using the relation attribute D4 between the original RD and the target RD at step S25. Furthermore, the data processing module 23 generates an original RD having the authored content, the identification information, the correlation and the relation attribute as a single dataset and stores the original RD in the RD storage unit 31 at step S26. Furthermore, when relation attributes are suggested by the relation attribute recommendation unit but the author does not enter a relation attribute, the relation setting module 22 deletes previously collected RD correlations through resetting and repeats the process from the RD correlation designation step S18.

For reference, the relation attribute recommendation unit analyzes the authored content of the original RD and the authored content of the target RD having a correlation with the original RD, searches for optimum relation attributes, and displays the results of the search together with numerical accuracies in the relation attribute recommendation window L5. For the analysis of the authored content of the RDs and the recommendation of the relation attributes, a widely used deep learning algorithm such as a Convolutional Neural Network (CNN) model may be utilized.

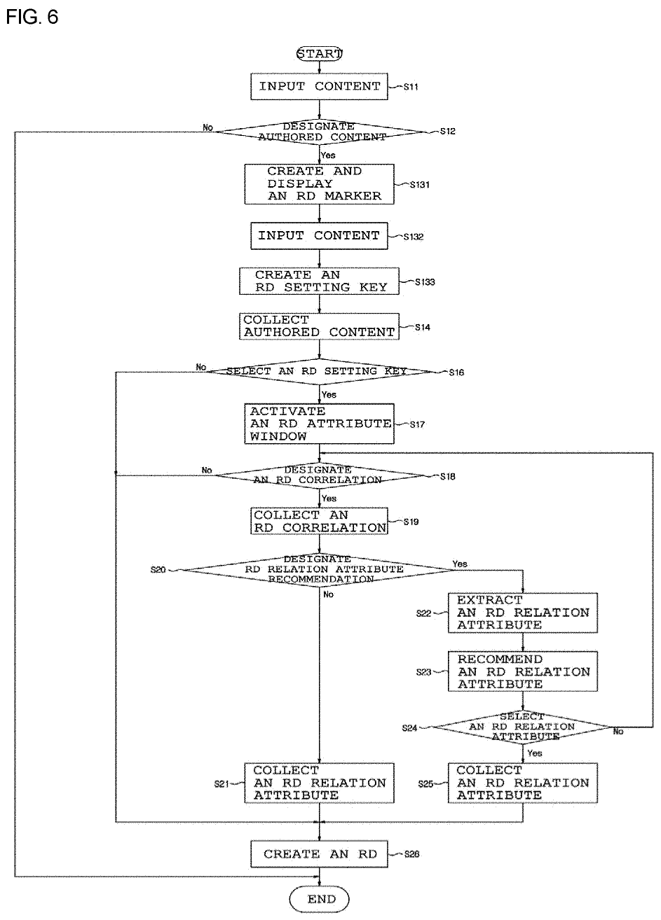

As described with reference to FIGS. 1 to 5, the author may allow an RD according to the present invention to be generated for a document, a paragraph, a sentence, or a phrase or word after the document has been created. By the way, it may be convenient for the creation and management of a document for the author to allow an RD to be generated at the same time as a document is created. This will be described with reference to FIG. 6.

FIG. 6 is a flowchart showing a process in which an RD is generated as content is created as another example according to the present invention. In this case, the reference numerals that are the same as those described and illustrated with reference to FIG. 2 denote the same steps having the same results.

Referring to FIG. 6, as the other example according to the present invention, the process of generating an RD is the same as the step of generating an RD described and illustrated with reference to FIG. 2, but they are different only in the collection of stored content according to the display of an RD marker, the input of content, and the generation of an RD setting key.

First, when the content to be input is intended to be an original RD, the author designates a location by entering an RD marker K1 (see FIG. 3) via an input device before inputting the content at step S131. When content is created after the entry of the marker K1 at step S132 and an RD setting key K2 (see FIG. 3) is generated via the input device at step S133, the authoring module 11 allocates identification information D2 (see FIG. 3) to content located between the RD marker K1 and the RD setting key K2 and collects it by classifying it as authored content D1 (see FIG. 3) at step S14. Furthermore, a subsequent process generates and stores an RD at the same steps as described and illustrated with reference to FIGS. 3 to 5, and a detailed description thereof will be omitted to avoid redundant description.

As described above, the RD according to the present invention may be generated subsequently, but may be generated at a work generation step. Accordingly, it is easy to determine the flow of changes in the authored content because the connection between the thoughts of an author may be reflected and expressed in the authored content as it is, it may be also managed as knowledge data in the relevant field, and a benefit is achieved in that there may be implemented a management system in which the authoring and management of electronic documents and authored content are always associated with each other.

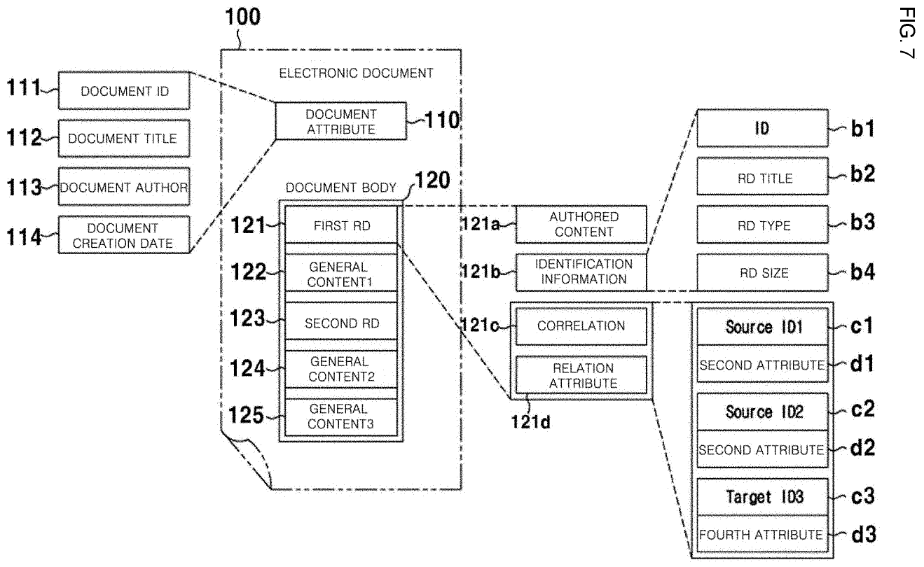

FIG. 7 is a block diagram showing the data structure of an electronic document generated by an authoring management system as one embodiment according to the present invention.

Referring to FIGS. 1 and 7, as one example of the generated authoring management system 1 according to the present invention, an electronic document 100 is divided into a document attribute 110 and a document body 120.

The document attribute 110 is the meta information of the electronic document 100, and includes a document ID 111, a document title 112, a document author 113, and a document creation date 114. The document attribute is generated by the authoring module 11 and stored in the electronic document storage unit 32 by the data processing module 23.

The document body 120 includes content constituting the content of a document created by the author, is generated by the authoring module 11, and is stored in the electronic document storage unit 32 by the data processing module 23. The content is divided into authored content 121a designated and managed as an RD and general content 122. In this case, the general content refers to general content 122, 124 and 125, excluding the authored content 121a designated and managed as an RD, in the document body. The illustrated example is an example in which two RDs are generated in the electronic document 100.

The RD includes the authored content 121a, identification information 121b, a correlation 121c, and a relation attribute 121d.

As described with reference to FIGS. 2 to 7, the authored content 121a is content C1 designated as an RD.

The identification information 121b is the information that enables the authored content to be distinguished from other authored content and then managed, and has an ID b1 having a unique identification value. The ID b1 is the information that enables the RD to be distinguished from other RDs and defined as an independent object, and may be allocated based on the creation time of the authored content D1, as described with reference to FIG. 2 above.

Furthermore, the ID b1 may be used by combining the creation time of the authored content 121a, a computer ID, and the document ID 111 for convenience of the author or search.

The correlation 121c includes source IDs c1 and c2 and a target ID c3 as information indicating whether or not there is a connection between pieces of authored content 121a. The target ID c3 refers to an ID in the identification information 121b of the target RD. The source IDs c1 and c2 are the identification information 121b of the source RDs designated by other RDs (hereinafter, an RD designated as having the correlation 121c with the original RD is referred to as the ‘source RD’ for ease of description) as having the correlation 121c. In this case, the ID b1, the source IDs c1 and c2, and the target ID c3 are the values allocated from the viewpoint of the original RD, and needs to be understood as being based on relative concepts that vary depending on designating or being designated. The source RD and the target RD need to be designated based on the directionality of the correlation 121c, which is a major factor that determines the relation attribute 121d.

The relation attribute 121d refers to the characteristic of a change between the authored content 121a having the correlation 121c, and the range, scope or definition thereof may be defined in various manners. Since this relation attribute 121d may be defined in various manners, it may not be determined uniquely. However, for convenience of understanding, four relation attributes 121d are illustrated. For example, a first attribute may be defined as ‘identification’ in the case where the pieces of authored content 121a of RDs are identical with each other, a second attribute may be defined as ‘concretization’ in the case where an addition is made to the authored content 121a of an RD having the correlation 121c, a third attribute may be defined as ‘partialization’ in the case where a target is part of the authored content 121a of an RD having the correlation 121c, and a fourth attribute may be defined as ‘progression’ in the case where a change and an addition are made to the authored content 121a of an RD having the correlation 121c.

As an example shown in FIG. 7, the electronic document 100 has two RDs 121 and 123. The first RD 121 has the relations 121c with three RDs, and has respective relation attributes accordingly. In this case, the second RD 123 may have various correlations and relation attributes depending on designating or being designated in a data structure illustrated as the first RD 121. In the illustrated example, the two RDs 121 and 123 are presented, but the number of RDs may be increased or decreased in various manners according to RD designation. Furthermore, for the convenience of explanation and understanding, the correlations 121c and relation attributes 121d of the first RD 121 will be described using the four attributes (‘first attribute’: ‘identification,’ ‘second attribute’: ‘concretization,’ ‘third attribute’: ‘partialization,’ and ‘fourth attribute’: ‘progression’) as an example.

The first RD 121 is an original RD having the ID b1. The first RD has the correlation 121c with the source ID1 c1 and the source ID2 c2, and has second attributes d1 and d2. This is an example in which the authored content 121a of the first RD 121 is concretized from the authored content of source ID1 c1 and designated as the second attribute d1, and is also an example in which the authored content 121a of the first RD 121 is concretized from the authored content of source ID2 c2 and designated as the second attribute d2. In addition, the first RD 121 has the correlation 121c with the target ID3 c3, and has a fourth attribute d3. This is an example in which the authored content 121a of the first RD 121 is progressed by content change and addition, has the relation 121c with the target ID3 c3, and is designated as the fourth attribute d3.

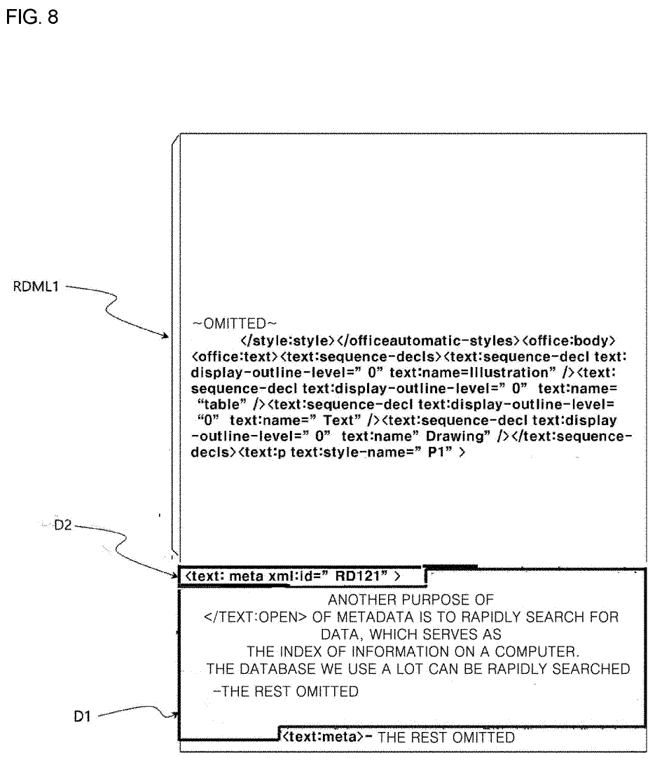

FIG. 8 shows an ML document for authored content as a preferred embodiment according to the present invention.

Referring to FIG. 8, RDML allows the per-text fonts, sizes and colors of the authored content D1, to be displayed via the electronic document authoring unit 10 (see FIG. 1), and the authored content D1 to be visually distinguished from general content, and presents the authored content designated by an RD marker and an RD setting key.

Furthermore, the RDML expresses the identification information D2 of the RD. In the ML of the present embodiment, the identification information D2 is expressed as <text:meta xml:id=‘RD121’>, and the authoring management system 1 (see FIG. 1) according to the present invention may identify the identification information D2 of the corresponding RD as ‘RD121’ and store and manage it in a data form.

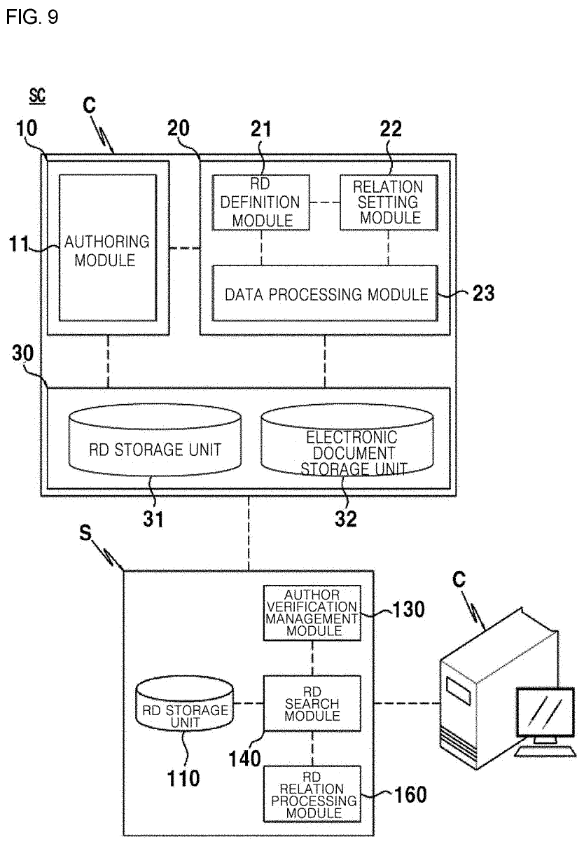

FIG. 9 is a block diagram showing an authoring management system composed of a server-client system as a preferred embodiment according to the present invention.

Referring to FIG. 9, the server-client system according to the present invention constitutes author clients C and C′ (hereinafter ‘C’) and a relation server S network system. In this case, the author clients C and the relation server S perform data communication using a TCP/IP-based HTTP protocol, and the data format may be based on a JSON (JavaScript Object Notation) method.

The relation server S manages the RDs of the author clients C in the form of a dataset while performing data communication with the author clients C, and relays and manages dataset exchange between the author clients C. Therefore, the RD information may be collected, exchanged, and efficiently managed by expanding the management system between the RDs to a global network such as the Internet as well as an Ethernet without limiting the management system to the range of the author clients C.

The author clients C of the server-client system SC according to the present invention includes the authoring management system 1 (see FIG. 1), and further includes a communication device for network communication and a communication process such as a web browser (not shown).

The relation server S of the server-client system SC according to the present invention further includes: an RD storage unit 110 configured to store RDs transmitted and shared by the author clients C; an RD search module 140 configured to search and store the data stored in the RD storage unit 110; and an RD relation processing module 160 configured to control the search operation of the RD search module 140 in response to a search signal of the author clients C and transmit a retrieved RD to a corresponding one of the author clients C.

Finally, the relation server S searches for a target RD to have a correlation in the author clients C for the purpose of creating an RD, transmits it to the author clients C, and stores and manages the RD, created in the author clients C, in the RD storage unit 110 of the relationship server S. In this case, the RD search of the RD search module 140 may be performed in various manners by using the authored content, identification information, correlation, and relation attribute of an RD as search conditions. Furthermore, the RD search module 140 may search a plurality of RDs that are concatenated with each other, and may allow a multidimensional visualization of the correlation structure among the plurality of RDs.

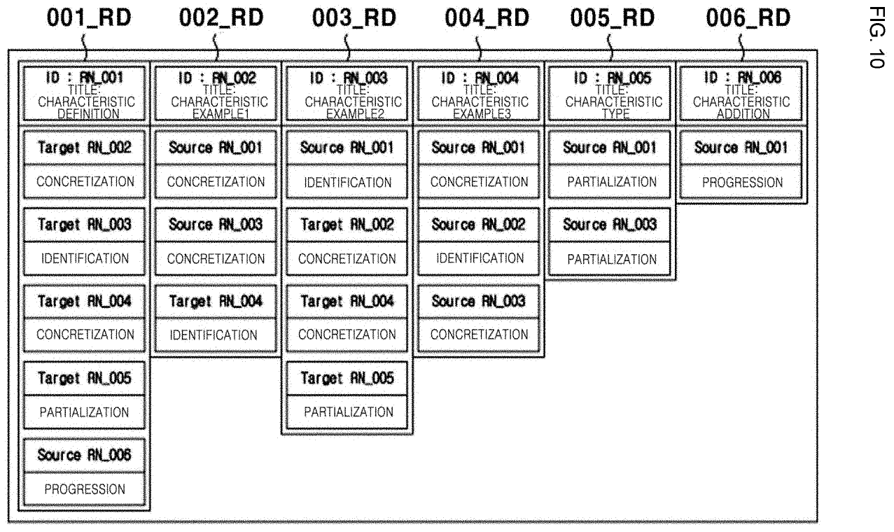

FIG. 10 shows the summary information of RDs as an example illustrating an authoring management method using RDs according to the present invention. In this case, the RD summary information includes identification information, a correlation, and a relation attribute. The source ID and the target ID are a correlation of an RD depending on being designated or designating, and ‘identification,’ ‘concretization,’ ‘partialization,’ and ‘progression’ are relation attributes. Each of the relation attributes has the same meaning as the example of the relation attribute described with reference to FIG. 5. Furthermore, six pieces of RD information are used for convenience of description. For convenience of description, an RD the ID of which is RN_001 is referred to as ‘001_RD,’ an RD the ID of which is RN_002 is referred to as ‘002_RD,’ an RD the ID of which is RN_003 is referred to as ‘003_RD,’ an RD the ID of which is RN_004 is referred to as ‘004_RD,’ an RD the ID of which is RN_005 is referred to as ‘005_RD,’ and an RD the ID of which is RN_006 is referred to as ‘006_RD.’

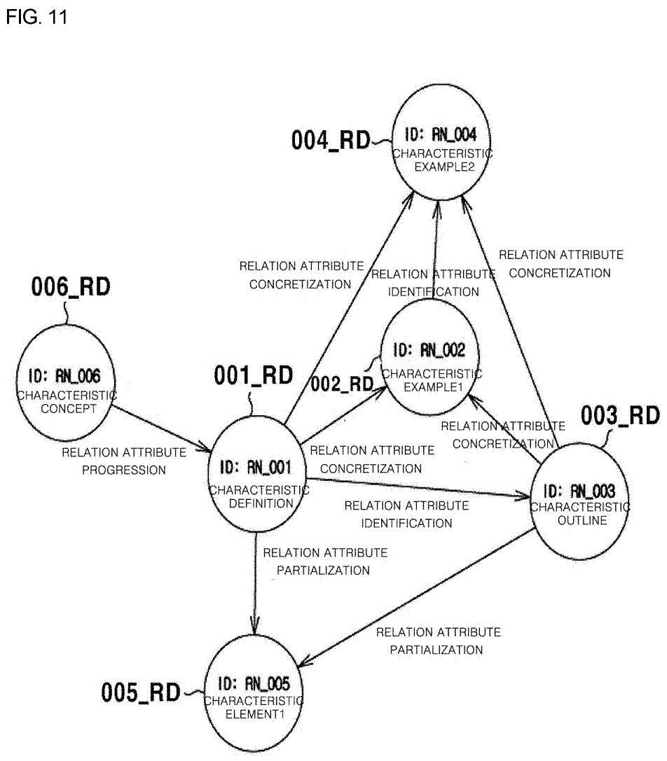

FIG. 11 is a diagram visually representing the summary information shown in FIG. 10 using nodes and edges. In this case, each of the nodes represents the object information of an RD as an example, and each of the edges represents the flow information and correlation between pieces of RD authored content. The content included in the node includes an ID and a title as the information of a corresponding RD, and the edge represents flow information and a correlation using a relation attribute and an arrow. The diagram composed of the nodes and edges is represented in a multidimensional form, such as a two-dimensional (2D) form or a three-dimensional (3D) foam, and is frequently used in various fields. In the case of the authoring management system according to the present invention, RDs may be freely and conveniently generated for an overall document, paragraphs, sentences, phrases, words, and/or the like, converted into data, and then managed. When the RD according to the present invention is applied to the node/edge diagram, it may be immediately and effectively used for analysis, verification, etc.

Referring to FIG. 10, 001_RD is related with 002_RD, 003_RD, 004_RD, 005_RD, and 006_RD by the correlation of the target ID and the relation attributes ‘concretization,’ ‘identification,’ ‘concretization,’ ‘partialization,’ and ‘progression.’ This means that the authored content of 002_RD, 003_RD, 004_RD, 005_RD, and 006_RD has been changed to the characteristics of ‘concretization,’ identification,’ ‘partialization,’ and ‘progression’ based on the authored content of 001_RD. This is visualized as shown in FIG. 11.

Furthermore, 001_RD is related with 006_RD by the correlation of the source ID and the relation attribute ‘progression.’ This means that the authored content of 001_RD has been changed to the characteristic ‘progression’ based on the authored content of 006_RD. This is visualized as shown in FIG. 11.

Referring to FIG. 10, 002_RD is related with 001_RD and 003_RD by the correlation of the source ID and the relation attribute ‘concretization.’ This means that the authored content of 002_RD has been changed to the characteristic ‘concretization’ based on the authored content of 001_RD and 003_RD. Furthermore, 002_RD is related with 004_RD by the correlation of the target ID and the relation attribute ‘identification.’ This means that the authored content of 004_RD has been changed to characteristic ‘identification’ based on the authored content of 002_RD. This is visualized as shown in FIG. 11.

Referring to FIG. 10, 003_RD is related with 001_RD by the correlation of the source ID and the relation attribute ‘concretization.’ This means that the authored content of 003_RD has been changed to the characteristic ‘concretization’ based on 001_RD. Furthermore, 003_RD is related with 002_RD and 004_RD by the correlation of the target ID and the relation attribute ‘concretization.’ This means that the authored content of 002_RD and 004_RD has been changed to the characteristic ‘concretization’ based on the authored content of 003_RD. This is visualized as shown in FIG. 11. Furthermore, 003_RD is related with 005_RD by the correlation of the target ID and the relation attribute ‘partialization.’ This means that the authored content of 005_RD has been changed to the characteristic ‘partialization’ based on the authored content of 003_RD. This is visualized as shown in FIG. 11.

Referring to FIG. 10, 004_RD is related with 001_RD, 002_RD and 003_RD by the correlation of the source ID and the relation attributes ‘concretization,’ ‘identification’ and ‘concretization.’ This means that the authored content of 004_RD has been changed to the characteristics ‘concretization,’ ‘identification’ and ‘concretization’ based on the authored content of 001_RD, 002_RD and 003_RD. This is visualized as shown in FIG. 11.

Referring to FIG. 10, 005_RD is related with 001_RD and 003_RD by the correlation of the source ID and the relation attribute ‘partialization.’ This means that the authored content of 005_RD has been changed to the characteristic ‘partialization’ based on the authored content of 001_RD and 003_RD. This is visualized as shown in FIG. 11.

Referring to FIG. 10, 006_RD is related with 001_RD by the correlation of the source ID and the relation attribute ‘progression.’ This means that the authored content of 001_RD has been changed to the characteristic ‘progression’ based on the authored content of 006_RD. This is visualized as shown in FIG. 11.

As described above, when RDs are generated for an overall document, paragraphs, sentences, phrases, and/or words, respectively, converted into data, stored and managed according to the present invention, it is possible to clearly review/analyze the change flow of each piece of authored content. In addition, even in the case where a project is performed in a recent server-client environment for sharing and collaboration, complicatedly related authored content is stratified or subdivided, so that it is possible to manage multiple and/or large quantities of electronic documents in an integrated manner and flexible document management or authoring management is provided, with the result that a working environment may be improved and an economical authoring environment may be provided. Unlike conventional methods that rely on individual research documents, research notes, and individual intellectual management by researchers, the present invention may check and track research progress at all times and also perform partial or full verification, review, and analysis based on revision at all times between authors or organizations through semantic-based correlation review and verification, thereby enabling efficient project progress and management. Accordingly, it is preferable that the authoring management system according to the present invention enables individual-level document authoring and management and also the authoring management system according to the present invention may be applied to large-scale tasks within an organization, between organizations, and at a society level.

Meanwhile, in the case of the authoring management method and authoring management system according to the present invention, authored content is organically related to each other by RDs, and thus it is effective in recommending or verifying the authored content. This will be described with reference to FIG. 11.

A process of verifying 001_RD and 005_RD will be described with reference to FIG. 11. The authored content of the 001_RD is related with the ‘identification’ of the authored content of 003_RD and the authored content of 005_RD is related with the ‘partialization’ of the authored content of 003_RD, with the result that the authored content of 005_RD needs to be related with the ‘partialization’ of the authored content of 001_RD. Nevertheless, when a relation attribute other than ‘partialization’ such as ‘progression’ or ‘concretization’ is designated as the relation attribute in the process of creating 005_RD, this corresponds to inconsistency. In this case, the authoring management system according to the present invention determines that the verification result is ‘inconsistency,’ and then recommends the relation attribute ‘partialization’ to the author or informs the author of the inconsistency so that it can be reviewed and reset.

Next, a process of verifying 001_RD and 002_RD will now be discussed. The authored content of 001_RD corresponds to the ‘identification’ of the authored content of 003_RD and the authored content of 002_RD has the characteristic of the ‘concretization’ of the authored content of 003_RD, with the result that the authored content of 002_RD needs to have the characteristic of the ‘concretization’ of the authored content of 001_RD.

Furthermore, a process of verifying 001_RD and 004_RD will now be discussed. The authored content of 002_RD has the characteristic of the ‘concretization’ of the authored content of 001_RD and the authored content of 002_RD corresponds to the ‘identification’ of the authored content of 004_RD, with the result that the authored content of 004_RD needs to have the characteristic of the ‘concretization’ of the authored content of 001_RD.

Furthermore, a process of verifying 003_RD and 004_RD will now be discussed. The authored content of 002_RD has the characteristic of the ‘concretization’ of the authored content of 003_RD and the authored content of 002_RD corresponds to the ‘identification’ of the authored content of 004_RD, with the result that the authored content of 004_RD needs to have the characteristic of the ‘concretization’ of the authored content of 003_RD.

Furthermore, a process of verifying 001_RD and 004_RD will now be discussed. the authored content of 002_RD has the characteristic of the ‘concretization’ of the authored content of 001_RD and the authored content of 002_RD corresponds to the ‘identification’ of the authored content of 004_RD, with the result that the authored content of 004_RD needs to have the characteristic of the ‘concretization’ of the authored content of 003_RD.

Next, a verification process in the case where the relation attributes of verification targets overlap each other will now be discussed. Referring back to the above-described process of verifying 001_RD and 004_RD, 001_RD and 004_RD may be verified through not only the route of 001_RD and 003_RD but also the route of 003_RD and 004_RD.

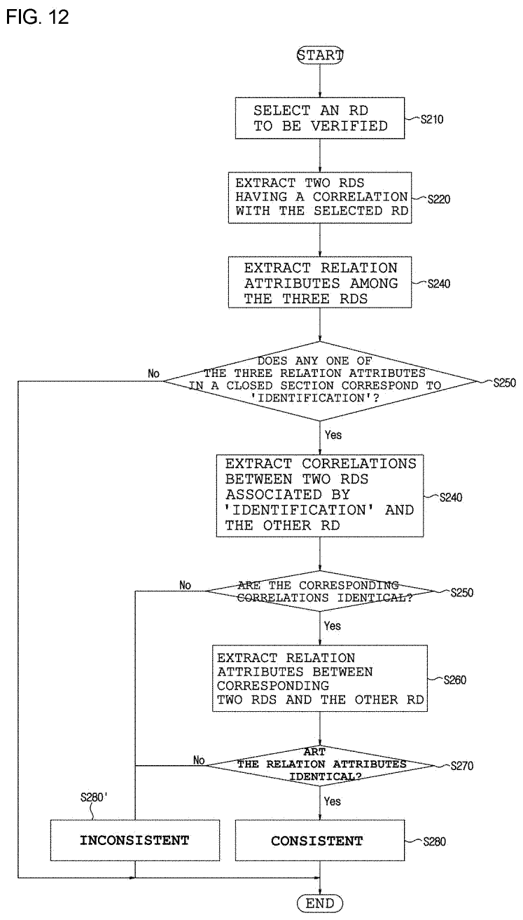

As described above, in the case where three RDs have correlations in the authoring management system according to the present invention, even when machine learning to be described below is not applied, an error in the relation attribute may be easily determined by a program and then verification or recommendation may be performed. Furthermore, as the correlations of RDs increase, verification routes increase, so the validity of verification increases. This will be described with reference to FIG. 12.

FIG. 12 is a flowchart showing a process illustrating the relation attribute verification process of an authoring management system as a preferred example according to the present invention.

Referring to FIGS. 11 and 12, the authoring management system according to the present invention selects an RD having a relation attribute to be verified at step S210. The authoring management system according to the present invention requires verification when an author desires to designate or recommend a relation attribute or a relation attribute is automatically set. For this purpose, an RD 001_RD having a relation attribute to be verified is selected and extracted.

When the corresponding RD 001_RD is selected, the data processing module 23 (see FIG. 1) extracts two RDs 002_RD and 003_RD having a correlation with the selected RD 001_RD at step S220, and determines whether or not the selected RD 001_RD corresponds to a closed section. In this case, when the selected RD 001_RD have correlations with the extracted two RDs 002_RD and 003_RD, it is determined that a closed section is formed.

When the selected RD 001_RD is not configured in the closed section, verification is terminated, and verification is performed by a learning modeling method to be described later. In addition, when the selected RD 001_RD is configured in a closed section, a correlation is extracted from the extracted two RDs 002_RD and 003_RD. Furthermore, a correlation having the relation attribute ‘identification’ is extracted from the closed section of the selected RD 001_RD at step S240.

Whether or not correlations are the same is determined based on the directionality of two RDs. Accordingly, the correlation between 001_RD and 002_RD and the correlation between 002_RD and 003_RD are the same.

When it is determined at step S250 that the correlations are the same, the relational attributes of the corresponding two RDs 001_RD and 003_RD and the other RD 002_RD are extracted at step S260.

In this case, ‘identification,’ which is one of the relation attributes, does not refer to the meaning of the substantive, semantic, or morphological identification of authored content, but refers to a relation attribute as the characteristic of the change of the authored content. When the relation attribute ‘identification’ is defined as a case where a sematic and/or morphological change in authored content is insignificant and thus two RDs fall within a substantially same category, this case may be determined to have the relation attribute ‘identification.’

When, as a result of the verification, the relation attributes are the same at step S270, it is determined that the result of the verification is consistency at step S280. When the relation attributes are not the same, it is determined that the result of the verification is inconsistency at step S280′.

In the present embodiment, the relation attributes of 001_RD and 002_RD and the relation attributes of 002_RD and 003_RD are the same as ‘concretization,’ and thus it is determined as a result of the verification that the relation attributes among 001_RD, 002_RD and 003_RD constituting a closed section are consistent with each other.

First, machine learning will now be discussed. Generally, machine learning includes supervised learning, unsupervised learning, and semi-supervised learning. Unsupervised learning, represented by clustering, does not require a learning label (target value) or training data, whereas semi-supervised learning or supervised learning requires a learning label and training data because it is a learning method that finds output that fits input. Although examples of the supervised learning include decision trees, support vector machines, and artificial neural networks, interest in XGBoost or deep learning is increasing recently. Recently, Generative Adversarial Networks (GANs) have been attracting attention, but leave many challenges in the field of natural language processing. In spite of such numerous learning models, refined learning data is very important for machine learning.

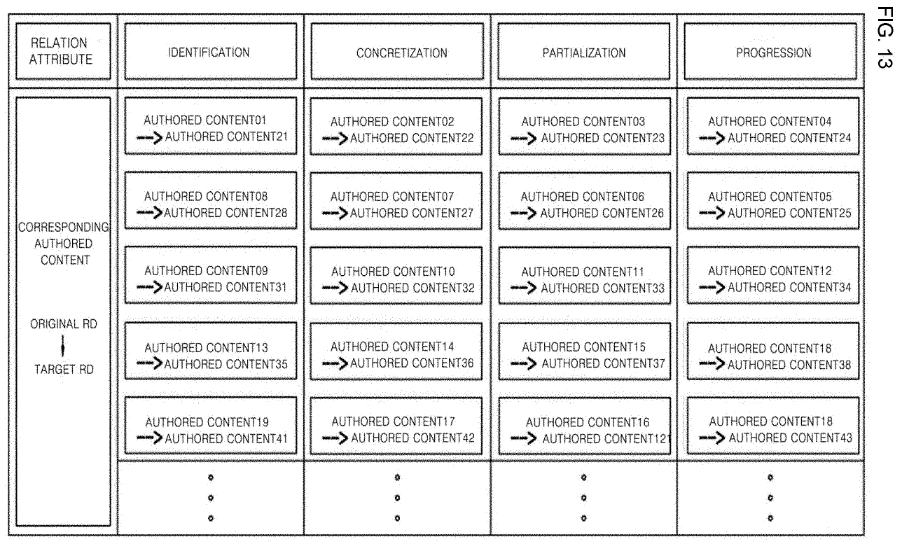

FIG. 13 schematically shows a table of relation attributes and authored content of RDs as a preferred example according to the present invention. In this case, for convenience of description and understanding, authored content and relation attributes are arbitrarily marked.

Referring to FIG. 13, relation attributes are allocated as the column names to the table, and pieces of authored content are located for each relation attribute. In this case, the relation attributes and the authored content are the data designated by the author when the RDs are created. The relation attributes and the authored content may be viewed as reflecting and expressing the connection between the thoughts of an author. Accordingly, the relation attributes and authored content of the table may be beneficially used as refined learning data. Moreover, when authored content and relation attributes are verified by the verification process described with reference to FIG. 12 and also data is classified/organized as RDs are accumulated, there may be obtained data that is beneficial as learning data that can train a model. This means that the labor of collecting refined learning data, which is essential for classification of machine learning, may be avoided.

Furthermore, the author may refer to the history of relation attributes between the original and target RDs designated by himself or herself to designate a subsequent relation attribute while storing and managing the history of relation attributes. The relation setting module 22 may determine the relation attribute setting pattern of the corresponding author from the cumulative data. Furthermore, the relation setting module 22 may automatically set a relation attribute according to the setting pattern of the author determined as described above.

Furthermore, although machine learning models applicable to the authoring management system according to the present invention may be various, a convolutional neural network (CNN) model is preferable because a CNN is recently widely used as a text classifier in the field of natural language processing as a deep learning model. The CNN model may be implemented by open source software such as Google's Tensor Flow and Keras, Apache MXNet, Microsoft's CNTK, and Facebook's Caffe. In other words, the relation attributes of the authored content of a verification target RD may be predicted by selecting a CNN model, arranging training data (relation attributes, and authored content), fitting the training data to the model (CNN), and applying the verification target RD to the trained model. Since a specific method using the CNN model is well known in the field of the present invention, a detailed description thereof will be omitted below.

As described above, the authoring management method and authoring management system according to the present invention have been described in more detail, but this is illustrated and described as examples. It is obvious that those having ordinary skill in the art to which the present invention pertains may freely and variously make modifications within the scope of the technical spirit of the present invention. Therefore, the scope of protection of the present invention should not be construed as being limited to the detailed description of the invention or the accompanying drawings, but should be defined by the appended claims.

1. An authoring management method comprising:
a content designated section setting step of setting a designated section of content by input keys of an input device;
an authored content collection step of collecting content of an electronic work, located in the designated section, as authored content;
an identification information generation step of generating identification information about the authored content;
a correlation collection step of collecting a correlation between the authored content and other authored content;
a relation attribute collection step of collecting a relation attribute for a characteristic of a change between the authored content and the other authored content; and
an RD generation step of generating an RD by converting the authored content, the identification information, the correlation, and the relation attribute into a dataset.

2. The authoring management method of claim 1, wherein the content designated section setting step comprises an RD marker marking step of marking an RD marker at a start point of the designated section.

3. The authoring management method of claim 1, wherein the content designated section setting step comprises an RD setting key generation step of generating an RD setting key at an end point of the designated section.

4. The authoring management method of claim 3, wherein the RD setting key generation step comprises an RD attribute window activation step of, when the RD setting key is selected, activating an RD attribute window, in which a correlation input unit and a relation attribute input unit are provided, in a task window.

5. The authoring management method of claim 4, wherein the correlation collection step comprises collecting an input value of the correlation input unit as the correlation, and the relation attribute collection step comprises collecting an input value of the relation attribute input unit as the relation attribute.

6. The authoring management method of claim 5, wherein the relation attribute collection step comprises a relation attribute verification step of, when among three RDs having a correlation among them, a relation attribute having an identification characteristic is present between two RDs of the three relation attributes and the corresponding two RDs have a same correlation with a remaining one RD, verifying that the other two relation attributes have relation attributes having a same characteristic.

7. The authoring management method of claim 4 6, wherein:
the correlation input unit configured such that a target correlation, in which the authored content is changed to other authored content, or a source correlation, in which the authored content is changed from other authored content, is input; and
the relation attribute input unit configured such that a target relation attribute, in which the authored content is changed to other authored content, or a source relation attribute, in which the authored content is changed from other authored content, is input.

8. The authoring management method of claim 7, wherein the relation attribute collection step comprises a correlation and relation attribute presentation step of, when the correlation input unit has an input value, presenting the correlation and the relation attribute by outputting the correlation and the relation attribute to the task window.

9. The authoring management method of claim 8, further comprising:
a diagram generation step of generating a diagram in which a plurality of nodes are interconnected with edges each having a direction; and
a visualization step of marking identification information in each of the nodes, marking a correlation and a relation attribute on each of the edges, and visualizing results of the marking in the task window.

10. The authoring management method of claim 9, wherein the relation attribute comprises one or more selected from among:
a relation attribute defined as identification when a characteristic of a change of authored content of the RD to authored content of another RD corresponds to an identical relation;
a relation attribute defined as concretization when a characteristic of a change of authored content of the RD to authored content of another RD corresponds to an addition relation;
a relation attribute defined as partialization when a characteristic of a change of authored content of the RD to authored content of another RD corresponds to an inclusion relation; and
a relation attribute defined as progression when a characteristic of a change of authored content of the RD to authored content of another RD corresponds to a change and addition relation.

11. An authoring management system comprising:
an authoring module configured to generate content by input of an input device;
an RD definition module configured to designate a section of the content, to allocate identification information to the section of the content, and to classify the section of the content as authored content;
a relation setting module configured to collect a correlation between the authored content and other RD authored content, and to collect a relation attribute for a characteristic of a change between the authored content and the other RD authored content; and
a data processing module configured to store an RD, obtained by converting the authored content, the identification information, the correlation, and the relation attribute into a dataset, in an RD storage unit.

12. The authoring management system of claim 11, further comprising an RD setting key configured to be generated by the authoring module so that the correlation and the relation attribute are input and to be located at an end point of a designated section of the content.

13. The authoring management system of claim 11, further comprising an RD marker configured to be displayed in a task window by the authoring module so that it is located at a start point of a designated section of the content.

14. The authoring management system of claim 12, further comprising an RD attribute window configured to be activated by the RD setting key so that the correlation or relation attribute is input.

15. The authoring management system of claim 14, wherein the RD attribute window comprises a correlation input unit configured such that a source correlation or a target correlation is input thereto and a correlation input unit configured such that a source relation attribute or a target relation attribute is input.

16. The authoring management method of claim 5, wherein:
the correlation input unit configured such that a target correlation, in which the authored content is changed to other authored content, or a source correlation, in which the authored content is changed from other authored content, is input; and
the relation attribute input unit configured such that a target relation attribute, in which the authored content is changed to other authored content, or a source relation attribute, in which the authored content is changed from other authored content, is input.
